(19) United States
(12) Patent Application Publication
(10) Pub. No.: US 2014/0339349 A1
(43) Pub. Date: Nov. 20, 2014

(54) Flexile, Hollow Connector to Loop Cords

(71) Applicant: Jason G. Johnson, Henderson, NV (US)

(72) Inventor: Jason G. Johnson, Henderson, NV (US)

(21) Appl. No.: 14/449,788

(22) Filed: Aug. 1, 2014

Related U.S. Application Data
(63) Continuation of application No. PCT/US2013/024256, filed on Feb. 1, 2013.
(60) Provisional application No. 61/594,489, filed on Feb. 3, 2012.

(51) Int. Cl. B65H 75/36; H04R 1/10

(52) U.S. Cl. CPC B65H 75/36; H04R 1/1033; B65H 2701/3919
USPC 242/118.3

(57) ABSTRACT

Provided herein are devices or connectors for looping a cord, for example, a headset cord. The device comprises a flexible hollow connector having a body and a head disposed on the body such that a single hollow core is formed within the body and head. A slit or opening into the hollow core extends from the head along at least part of the length of the hollow body. Also provided are systems for looping the cord comprising the connectors described herein, a flexible sleeve having the connector disposed in one end of the sleeve and a headset cord disposed within the flexible sleeve such that the earbud end of the cord pass through the device and depend therefrom and the phono plug end of the cord extend from the other end of the sleeve to be inserted into the connector.

### CROSS-REFERENCE TO RELATED APPLICATION

This application is a continuation under 35 U.S.C. §120 of pending international application PCT/US2013/024256, filed Feb. 1, 2013 which claims benefit of priority under 35 U.S.C. §119(e) of provisional application U.S. Ser. No. 61/594,489, filed Feb. 3, 2012, now abandoned, the entirety of which is hereby incorporated by reference.

### BACKGROUND OF THE INVENTION

1. Field of the invention

The present invention relates generally to a flexible device for joining opposing ends of a cord, cable or line. More specifically, the present invention relates to a flexible, hollow connector for use with a flexible sleeve containing a cord, cable or line to form a loop thereof.

2. Description of the Related Art

In today's electronic world, a plethora of handheld electronic devices are available each of which requires a distinctive plug or jack for connection to a battery charger or to headset. Thus, as an individual acquires these devices, such as a cell phone or MP3 player, one also acquires cords that must be carried with the device. Simply storing one or more of these cords in a backpack, case, purse, or even a pocket usually results in tangling to the cords with possible resulting damage.

U.S. Pat. No. 7,202,414 discloses an apparatus for manipulating a cord, such as a hands-free headset. An elastic sleeve encases the cord and helps to keep the cord from becoming entangled when not in use. In a retracted configuration the elastic sleeve containing the cord may be stored in a small space, such as a pocket. However, a pocket is not necessarily secure and, moreover, a user may not have a suitable pocket in his or her clothing. A purse, backpack or bag is not as accessible as a pocket and although the headset per se is protected from entanglement in the elastic sleeve, the sleeve is dropped in amongst the other articles in these carriers.

There is a recognized need for a simple device that enables a closed loop to be formed from a cord while keeping the cord unentangled. Specifically, the prior art is deficient in a flexible, hollow connector configured to receive both ends of a cord, for example a headset, to form a secure, closed loop therefrom that is wearable by a user. The present invention fulfills this longstanding need and desire in the art.

### SUMMARY OF THE INVENTION

The present invention is directed to a device for looping a cord. The device comprises a flexible, hollow pin-like structure having an elongate slit disposed along the length thereof. The present invention is directed to a related device comprising the flexible, hollow pin-like structure. The related device comprises a hollow body having a proximal open end and a distal open end, a head disposed around and extending laterally from the proximal open end of the hollow body where the hollow body and the head form a single hollow core therethrough and the elongate slit, as described.

The present invention also is directed to a system for looping a cord. The system comprises the flexible hollow pin-like structure described herein and a flexible sleeve having proximal and distal open ends. The flexible hollow pin-like structure is disposed within the proximal end of the flexible sleeve such that a proximal end of the pin-like structure protrudes from and abuts against the proximal open end of the flexible sleeve. The present invention is directed to a related system further comprising a cord disposed within the flexible sleeve such that a first end of the cord extends through the hollow pin-like structure and a second end of the cord extends from the distal open end of the flexible sleeve. The hollow pin-like structure is configured to flexibly receive the second cord end therein in a loop configuration.

The present invention is directed further to a connector for looping a headset cord. The connector comprises a flexible hollow body portion having proximal and distal open ends. A flexible head portion is disposed around and extending laterally from the proximal open end of the body portion such that the body and head portions forming a single hollow core therethrough. An elongate slit extends through the head portion and along the length of the body portion.

The present invention is directed further still to a system for carrying a headset. The system comprises the connector described herein and a flexible sleeve having open receiving and connecting ends, said body portion of the device disposed within the receiving end and the head portion thereof abutting against the open receiving end of the flexible sleeve. A headset is contained within the elastic sleeve such that a first end of a cord comprising the headset depends from the hollow core comprising the head portion and a second end of the cord depends from the open connecting end of the flexible sleeve, said second cord end receivable within the head portion in a loop configuration.

Other and further aspects, features, and advantages of the present invention will be apparent from the following description of the presently preffered embodiments of the invention for the purpose of disclosure

### BRIEF DESCRIPTION OF THE DRAWINGS

So that the matter in which the above-recited features, advantages and objects of the inention, as well as others that will become clear, are attained and can be understood in detail, more particular descriptions of the invention briefly summarized above may be had by reference to certain embodiments threof that are illustrated in the appended drawings. These drawings form a part of the specification. It is to be noted, however, that the appended drawings illustrate preferred embodiments of the invention and therefore are not to be considered limiting in their scope.

FIG. 1A is a perspective view of the flexible connector.

FIG. 1B is a perspective view of an alternative connector.

FIG. 1C is a side view of the flexible connector of FIG. 1A demonstrating the flexibility of the connector.

FIG. 2 illustrates the joining of the phono plug with the flexible connector.

FIG. 3A depicts the looped headset showing the phono plug and ear buds ends of the headset.

FIG. 3B depicts the looped headset with the flexible sleeve covering the phono plug.

FIG. 4 illustrates a user wearing the looped flexible sleeve around the wrist.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similary, the word “or” is intended to include “and” unless the context clearly indicates otherwise. “Comprise” means “include”.

As used herein, the term “about” refers to a numeric value, including, for example, whole numbers, fractions, and percentages, whether or not explicitly indicated. The term “about” generally refers to a range of numerical values, e.g., ±5-10% of the recited value, that one of ordinary skill in the art would consider equivalent to the recited value, e.g., having the same function or result. In some instances, the term “about” may include numerical values that are rounded to the nearest significant figure.

As used herein the phrases “in one embodiment” or “in another embodiment”, etc. are meant to generally reference embodiment possibilities and are not intended to limit the invention to those particular embodiment configurations and that other configurations are contemplated.

As used herein, the term “connected”, “connecting” or “connectable” means communicatively connected, connecting or connectable, unless otherwise indicated.

As used herein, the terms “connector” “flexible connector”, “flexible, hollow connector”, and “hollow pin-like connector” or similar variations all refer to the device described herein.

As used herein, the terms “proximal” and “distal” refer, respectively, to the head and body ends or portions of the device or connector and to, respectively, nearer to or farther from the connector device in a looping or connecting system.

In one embodiment of the present invention there is provided a device for looping a cord, comprising a flexible, hollow pin-like structure having an elongate slit disposed along the length thereof. In an aspect of this embodiment the flexible, hollow pin-like structure may comrise a hollow body having a proximal open end and a distal open end; and a head disposed around and extending laterally from the proximal open end of the hollow body, where the hollow body and the head forms a single hollow core therethrough.

In this embodiment and aspect thereof, the flexible, hollow pin-like structure may have a shape, including but not limited to, a cylindrical shape, a rectangular prism shape, a triangular prism shape or a combination thereof. In addition, the flexible, hollow pin-like structure may be configured to receive one or more cords therethrough.

In addition, the flexible, hollow pin-like structure may comprise a moldable polymer material. Furthermore, the elongate slit may extend along all the length of the pin-like structure or may extend to an intermediate position thereon. Further still, the elongate slit may be disposed such that the pin-like structure flexes when receiving one or more cords therethrough. An example of the one or more cords are cords comprising a headset.

In another embodiment of the present invention, there is provided a system for looping a cord, comprising the flexible hollow pin-like structure described supra; a flexible sleeve having proximal and distal open ends, where the flexible hollow pin-like structure is disposed within the proximal end of the flexible sleeve such that a proximal end of the pin-like structure protrudes from and abuts against the proximal open end of the flexible sleeve. In a further embodiment, the system comprises a cord disposed within the flexible sleeve such that a first end of the cord extends through the hollow pin-like structure and a second end of the cord extends from the distal open end of the flexible sleeve, said hollow pin-like structure configured to flexibly receive the second cord end therein in a loop configuration.

In both embodiments, the cord may be a headset cord whereby the first end comprises earbuds and the second end comprises a phono plug, said phono plug receivable within the hollow pin-like structure. Also, the cord loop is wearable around a neck or wrist of a user of the cord. In addition the flexible sleeve comprises an elastic material. A representative example of an elastic material is latex.

In yet another embodiment of the present invention, there is provided a connector for looping a headset cord, comprising a flexible hollow body portion having proximal and distal open ends; a flexible head portion disposed around and extending laterally from the proximal open end of the body portion, where the body and head portions form a single hollow core therethrough; and an elongate slit extending through the head portion and along the length of the body portion.

In this embodiment, the body and head portions may comprise a moldable polymer material. Also, the body and head portions may comprise a cylindrical shape, a rectangular prism shape, or a triangular prism shape. In one aspect of this embodiment the elongate slit may extend to the distal open end of the body portion. In an alternative aspect the elongate slit may extend to an intermediate position along the body portion. In addition, the elongate slit may be disposed such that one or both of the head portion and the body portion flexes when receiving one or more headset cords therethrough.

In yet another embodiment of the present invention, there is a provided system for carrying a headset, comprising the connector described supra; a flexible sleeve having open receiving and connecting ends, said body portion of the device disposed within the receiving end and the head portion thereof abutting against the open receiving end of the flexible sleeve; a headset contained within the elastic sleeve such that a first end of a cord comprising the headset depends from the hollow core comprising the head portion and a second end of the cord depends from the open connecting end of the flexible sleeve, where the second cord end is receivable within the head portion in a loop configuration.

In this embodiment the first end of the headset cord may comprise earbuds depending therefrom and the second end of the headset cord may comprise a phono plug. Also, the flexible sleeve may comprise an elastic latex material. In addition the headset loop is wearable around a neck or wrist of a user thereof.

Provided herein are a device and system that enable a cord, line, cable, etc. to be looped for secure and unentangled transporting or carrying by a user. The device is a connector comprising a hollow, pin-like body and head. The connector has a slit or opening disposed at least through the head. Preferably, the slit or opening is disposed along the length of the connector to extend from and through the head to the distal end of the body. The connector device may comprise a flexible, moldable polymer material and may be formed by, although not limited to, injection molding. The opening or slit enables all or part of the connector to flex from a relaxed position and/or to maintain a flexed position when accommodating an object therein, for example an object comprising or attached to one or more cords .

The connector may have a variety of shapes, configurations and sizes to accommodate different cords, lines or cables and different numbers thereof. The connector may be substantially shaped as a cyclinder, a rectangular prism, a triangular prism, or as a combination thereof. In any shape, the connector comprises a hollow core. The size and dimensions of the connector are dependent on the type and number of cords passing therethrough. For example, the connector may have a cylindrical shape with a body length of about 2.5 cm and a head about 0.3 cm. The hollow core may have a diameter of about 0.4 cm. The head end of the connector may be lipped, flared or flanged. The head end of the connector may be smooth and rounded.

Also provided is a system for connecting or looping one or more cords, for example, but not limited to, headset cords. The system comprises the connector described herein and a flexible sleeve having opposing proximal and distal open ends configured to contain the cords of the headset. The sleeve may comprise a flexible material. Preferably, the sleeve is an elastic sleeve suitable to contain a headset. A nonlimiting example of an elastic sleeve is disclosed in U.S. Pat. No. 7,202,414 to the inventor, the entirety of which is hereby incorporated by reference. For example, the part or all of the elastic sleeve may comprise latex.

The connector shape is suitable to fit within the proximal opening of the flexible sleeve such that the connector body is inside the flexible sleeve and the connector head may extend from or fit over the open end of the flexible sleeve. The connector head may be affixed to the flexible sleeve, for example, by gluing, or by any other known and standard means in the art.

The connector is configured such that one or more cords, such as headset cords, extend through the elastic sleeve and through the hollow core of the connector when disposed within the flexible sleeve. In addition, the connector can accommodate an object, for example, but not limited to, a phono plug while the one or more cords extend through the connector. For example, the slit or opening provides flexibility to the connector head to allow it to accommodate the one or more cords and the phono plug, yet the connector head is sturdy enough to support the firm grip of a user's fingers. At the same time, the connector securely holds the phono plug within the hollow cylindrical body.

The connector is configured to assist a user gripping the elastic sleeve in at least three ways. First, the cylindrical body of the connector enables the user to securely grip or squeeze the end of the elastic sleeve that contains the connector without gripping the cords extending through the elastic sleeve and the connector. Second, the connector head provides a protuberance against which the sides of a user's fingers can rest to prevent the user's fingers from slipping off the end of the elastic sleeve. Third, the surface of at least a portion of the elastic sleeve that fits over the connector may comprise a slide-resistant material.

Thus, the present invention provides a method for securely transporting or carrying a corded device, for example, a headset, without the worry of tangling or breaking that can occur when carried in a bag, backpack, purse, pocket, etc. The connector enables the headset, disposed within a protective sleeve to be looped around and fastened together via insertion of the phono plug into the connector, as described herein. The looped sleeve with headset may be worn around the neck or twisted or folded into a double loop and worn around the wrist. The headset is thereby protected and easily accessible. The loop is undone and the desired length of cord is pulled from within the sleeve when in use.

As described below, the invention provides a number of advantages and uses, however such advantages and uses are not limited by such description. Embodiments of the present invention are better illustrated with reference to the Figures, however, such reference is not meant to limit the present invention in any fashion. The embodiments and variations described in detail herein are to be interpreted by the appended claims and equivalents thereof.

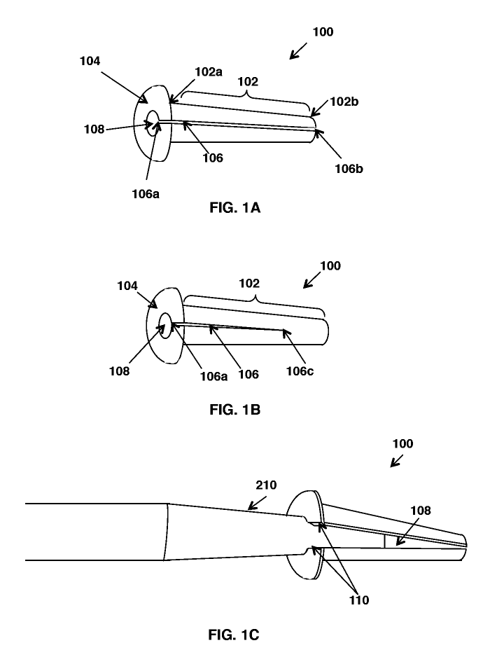

FIG. 1A depicts one embodiment of the device. The device comprises a connector 100 having a flexible, cylindrical body 102, a head 104 and a slit or opening 106 disposed along the length of the connector from the head at 106a to the distal end 102b of the cylindrical body at 106b. The connector has a hollow core 108 to which the slit or opening connects along the connector length. The connector head is circumferentially disposed around and extends laterally from the proximal end 102a of the cylindrical body.

FIG. 1B depicts an alternative embodiment of the device. The flexible connector 100 comprises the cylindrical body 102, head 104 and hollow core 108. The slit or opening 106 is disposed from the head at 106a along the length of the cylindrical body to a point at 106c between the proximal 102a and distal 102b ends thereof. The point 106c is representative of all points between the proximal and distal ends and is not intended to limit this embodiment. One of ordinary skill in the art can readily understand how the slit or opening 106 can extend along the cylindrical body to various lengths.

With continued reference to FIG. 1A, FIG. 1C demonstrates the flexibility of the connector. The opening or slit 106 in the connector 100 is sufficiently flexible to accommodate the insertion of an object 210. It is to be noted that the object shown in FIG. 1C is simply representative of any object for which the connector is designed to accommodate, for example, but not limited to, a phono jack on a headset. The combination of the material from which the device is made and the positioning of the opening or slit along the length of the connector provides the flexibility of the device. As the object is inserted through the connector head 104 and into the connector body 102, the device widens along the opening or slit at 110 to accommodate the object width-wise and length-wise as is needed to hold the object securely within the hollow core.

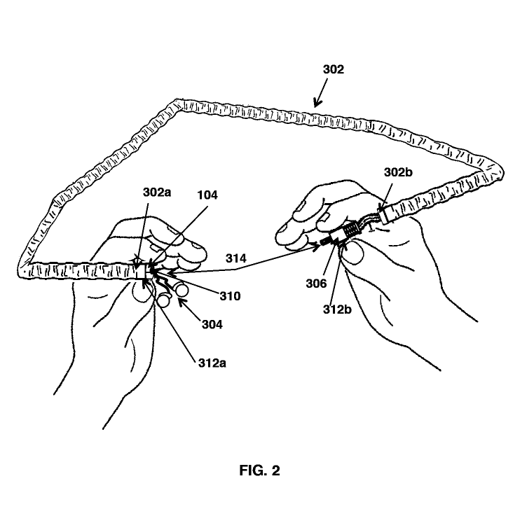

With continued reference to FIG. 1A, FIG. 2 depicts a user holding the connector system prior to looping the headphone cords via the flexible, hollow connector. A flexible, preferably elastic, sleeve 302 comprises proximal 302a and distal 302b open ends. The connector 100 is positioned within the open proximal end of the flexible sleeve such that the connector head 104 protrudes from and abuts against the proximal open end. A headset cord (not shown), but represented by the earbuds 304 at a first end of the headset cord and the phono plug 306 at a second end of the headset cord, is disposed within the flexible sleeve 302. The cord passes through the hollow core (not shown) of the connector such that the earbuds depend from the connector head at 310. The phono plug at the opposite end of the headset cord extends from the distal end of the flexible sleeve with sufficient distance to be easily grasped with one hand of the user at 312b. The connector 100 within the sleeve is easily grasped by the other hand at 312a. The user brings the open ends of the flexible sleeve together along 314 and inserts the phono plug into the hollow core in the connector head at the point where the earbuds depend at 310.

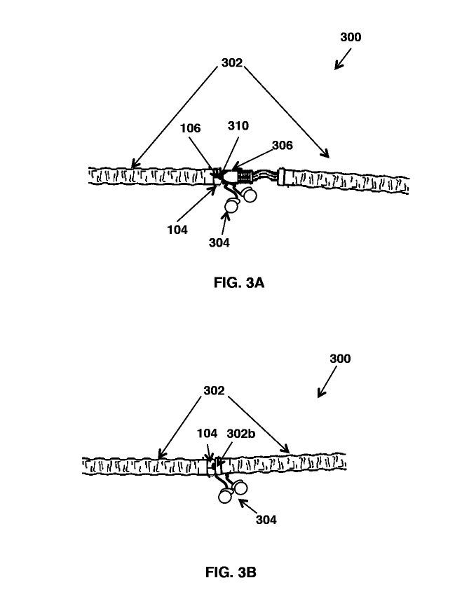

With continued reference FIG. 2, FIGS. 3A and 3B depict sections of the connection system 300 showing the phono plug inserted into the connector. In FIG. 3A the phono plug 306 is inserted within the hollow core of the connector 100 via the connector head 104 at 310. Due to the flexibility provided to the connector by the slit or opening 106, the connector head securely accommodates both the headphone cord and the phono plug while leaving the earbuds 304 depending from the connector head and thereby forms a secure, closed loop. FIG. 3B illustrates that the distal open end 302b of the flexible sleeve 302 can be extended or pulled over the phono plug to cover the same until the distal end of the sleeve abuts against the connector head without interfering with the earbuds 304.

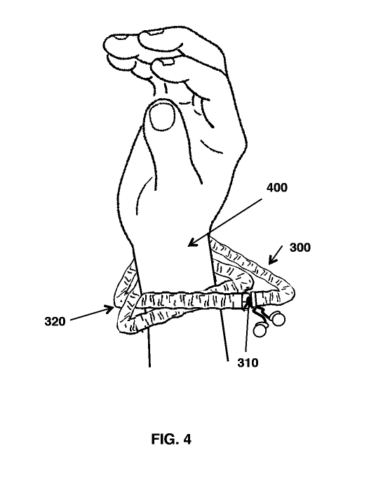

With continued reference to FIG. 3B, FIG. 4 depicts the looped headphone cords worn by a user. The connection system 300 comprising the headphone cords looped at 310 can be worn around the wrist 400 of a user. The flexibility of the sleeve 302 enables the sleeve to be twisted and double-looped at 320 and slid over the wrist. Although not shown, this embodiment includes wearing the looped headset around the neck as a single loop. Thus the headset is securely transported without tangling while remaining easily accessible.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible devices, systems and related methods available, the detailed embodiments are intended to be illustrative only and should not be taken as limiting the scope of the invention. Rather, what is claimed as the invention is all such modifications as may come within the spirit and scope of the following claims and equivalents thereto. None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A device for looping a cord, comprising:
a flexible, hollow pin-like structure having an elongate slit disposed along the length thereof.

2. The device of claim 1, wherein the flexible, hollow pin-like structure comprises:
a hollow body having a proximal open end and a distal open end; and
a head disposed around and extending laterally from the proximal open end of the hollow body, said hollow body and said head forming a single hollow core therethrough.

3. The device of claim 1, wherein the flexible, hollow pin-like structure has a cylindrical shape, a rectangular prism shape, a triangular prism shape or a combination thereof.

4. The device of claim 1, wherein the flexible, hollow pin-like structure is configured to receive one or more cords therethrough.

5. The device of claim 1, wherein the flexible, hollow pin-like structure comprises a moldable polymer material.

6. The device of claim 1, wherein the elongate slit extends along the length of the pin-like structure or the elongate slit extends to an intermediate position thereon.

7. The device of claim 1, wherein the elongate slit is disposed such that the pin-like structure flexes when receiving one or more cords therethrough.

8. The device of claim 7, wherein the one or more cords comprises a headset.

9. A system for looping a cord, comprising:
the flexible hollow pin-like structure of claim 1;
a flexible sleeve having proximal and distal open ends, said flexible hollow pin-like structure disposed within the proximal end of the flexible sleeve such that a proximal end of the pin-like structure protrudes from and abuts against the proximal open end of the flexible sleeve.

10. The system of claim 9, further comprising a cord disposed within the flexible sleeve such that a first end of the cord extends through the hollow pin-like structure and a second end of the cord extends from the distal open end of the flexible sleeve, said hollow pin-like structure configured to flexibly receive the second cord end therein in a loop configuration.

11. The system of claim 10, wherein the cord is a headset cord whereby the first end comprises earbuds and the second end comprises a phono plug, said phono plug receivable within the hollow pin-like structure.

12. The system of claim 10, wherein said cord loop is wearable around a neck or wrist of a user of the cord.

13. The system of claim 9, wherein the flexible sleeve comprises an elastic material.

14. The system of claim 12, wherein the elastic material is latex.

15. A connector for looping a headset cord, comprising:
a flexible hollow body portion having proximal and distal open ends;
a flexible head portion disposed around and extending laterally from the proximal open end of the body portion, said body and head portions forming a single hollow core therethrough; and
an elongate slit extending through the head portion and along the length of the body portion.

16. The connector of claim 15, wherein the body and head portions comprise a moldable polymer material.

17. The connector of claim 15, wherein the body and head portions individually comprise a cylindrical shape, a rectangular prism shape, or a triangular prism shape.

18. The connector of claim 15, wherein the elongate slit extends to the distal open end of the body portion or the elongate slit extends to an intermediate position along the body portion.

19. The connector of claim 15, wherein the elongate slit is disposed such that one or both of the head portion and the body portion flexes when receiving one or more headset cords therethrough.

20. A system for carrying a headset, comprising:
the connector of claim 15;
a flexible sleeve having open receiving and connecting ends, said body portion of the device disposed within the receiving end and said head portion thereof abutting against the open receiving end of the flexible sleeve;
a headset contained within the elastic sleeve such that a first end of a cord comprising the headset depends from the hollow core comprising the head portion and a second end of the cord depends from the open connecting end of the flexible sleeve, said second cord end receivable within the head portion in a loop configuration.

21. The system of claim 20, wherein the first end of the headset cord comprises earbuds depending therefrom and the second end of the headset cord comprises a phono plug.

22. The system of claim 20, wherein the flexible sleeve comprises an elastic latex material.

23. The system of claim 20, wherein the headset loop is wearable around a neck or wrist of a user thereof.
